(19) United States
(12) Patent Application Publication
(10) Pub. No.: US 2014/0297560 A1
(43) Pub. Date: Oct. 2, 2014

(54) METHOD AND SYSTEM FOR REBALANCING INVESTMENT PORTFOLIOS THAT CONTROL MAXIMUM LEVEL OF ROLLING ECONOMIC DRAWDOWN

(71) Applicant: SADDLE MOUNTAIN ASSOCIATES, LLC, Newark, DE (US)

(72) Inventors: ZHAOJI GEORGE YANG, NORTHVILLE, MI (US); LIANG ZHONG, NEWARK, DE (US)

(73) Assignee: SADDLE MOUNTAIN ASSOCIATES, LLC, Newark, DE (US)

(21) Appl. No.: 13/854,227

(22) Filed: Apr. 1, 2013

(51) Int. Cl. G06Q 40/00

(52) U.S. Cl. CPC G06Q 40/06
USPC 705/36 R

(57) ABSTRACT

A computer-implemented method and electronic system periodically select portfolio weightings for each of the plurality of assets to rebalance the investment portfolio at a pre-specified frequency. With a risk free asset, the portfolio can be optimal by maximizing long term expected return rate while constraining the risk of losses within a pre-determined limit.

Rather than return standard deviation, a portfolio risk measure called Rolling Economic Drawdown (REDD) is invented. Considering current and historical risk free interest rates, REDD represents the maximum economic opportunity loss within a rolling time window of fixed or variable look-back length. The pre-determined limit for REDD can be selected as complement of constant relative risk aversion coefficient, reflecting the level of risk tolerance. The dynamic weighting of each risky asset can be derived from the assets' long term expected Sharpe ratios and the assets' shorter term updated measure of correlations and volatilities.

### CLAIM OF PRIORITY

This application claims priority to U.S. Provisional Application No. 61/618,745 entitled “Methods and Systems of Constructing Optimal Investment Portfolios that Control Maximum Economic Drawdown during a Constant or Variable Time Window” filed Mar. 31, 2012 and the entirety of the above-noted application is incorporated here in by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

This invention relates generally to the field of computer implemented method and electronic systems for rebalancing investment portfolios in a dynamic asset allocation process, such that the portfolio can achieve maximized long term expected portfolio returns subjected to a limit of maximum tolerance of drawdown losses.

### BACKGROUND

Drawdown is a critically important risk measure for investment management. The common definition of drawdown of a portfolio is the percentage loss of current wealth Wₜ from a prior all-time high. The portfolio's downside risk of a prolonged drawdown matters not only to the investors' financial well-being, but also to the investment manager's business survival in an immediate term.

Collecting performance based fee, usually at 20% of annual profit, hedge fund managers have been known for the high watermark practice. If the portfolio ends a year that is lower in value than any of the previous year, the manager will not get any performance based compensation. Also drawdown causes account terminations or redemptions. Losing account assets undermines any investment business or even lead to its demise. When it comes to tolerating large drawdowns for a separate managed account, there is no or little regard to whether the strategy is valid in long run with high expected risk adjusted return—it simply cannot survive to that point!.

Maximum drawdown challenges a client's financial and psychological tolerance. According to Chekhlov et al (2005), 50% drawdown is unlikely to be tolerated in any average account, and an account may be closed if drawdown breaches 20% or has lasted over two years. For passive index investors, financial markets have been tough: maximum drawdown over 50% occurred for both the Dow Jones Industrial Average (DJIA) and the S&P 500 Index during the recent 2008-2009 financial crisis. A 50% drawdown, as pointed out by Zhou and Zhu (2009), however, is 90% probable to happen over a century even if the stock markets are simply modeled as random walk.

Despite being widely used, diversification through passive asset allocation was not effective to avoid large drawdowns. During a market crisis, risky asset classes can exhibit the “contagion” effect: highly correlated losses across the board lead to large drawdowns. Markowitz's (1952) modern portfolio theory (MPT) and Mean Variance Optimization (MVO) methodology defined risk as return standard deviation, a path-independent statistical attribute. Without an explicit mechanism to control maximum drawdown, it was not uncommon for a traditional balanced (60% stock+40% bond) portfolio suffering maximum drawdown loss of 30% during the 2008-2009 financial crises.

Grossman and Zhou (1993) pioneered the mathematical frame-work of portfolio optimization under the dynamic floor constraint to control maximum drawdown, extending the constant floor portfolio optimization by Black and Perold (1987)—the basis of the theory and practice of Constant Portion Portfolio Insurance (CPPI). Grossman and Zhou (1993) approached the problem with Expected Utility Theory and defined portfolio optimality as maximizing long term growth rate in power law wealth utility function U=W^{γ}/γ. The model assumed continuously rebalancing between a risk free asset and single risky asset, which has random walk return dynamics. Their drawdown calculation accounted the economic decay of portfolio value at the risk free rate r_{f}. An Economic Drawdown (EDD) was defined by EDD(t)=1−Wₜ/EM(t), where an Economic Max (EM) since inception is calculated as

$$EM ( t ) = {Max}_{0 \leq s \leq t} \{ {( 1 + {r}_{f} )}^{t - s} {W}_{s} \} .$$

The continues Drawdown-Controlled Portfolio Strategy (DD-COPS) has the portfolio fraction allocated to single risky asset as:

$${x}_{t} = ( \frac{λ / σ + 1 / 2}{1 - δ \cdot γ} ) \cdot [ \frac{δ - EDD ( t )}{1 - EDD ( t )} ]$$

where δ is the drawdown limit, (1-γ) is the constant relative risk aversion coefficient, and λ=(R−r_{f})/σ is the long term expected Sharpe ratio of the risky asset (R and σ are its long term expected return and volatility). The rest of the portfolio is allocated to the risk free asset. The risky asset allocation has a leverage factor

$$( \frac{λ / σ + 1 / 2}{1 - γ \cdot δ} ) ,$$

and is further scaled by

$$\frac{δ - EDD ( t )}{1 - EDD ( t )} ,$$

which adaptively controls drawdown. The case of δ=100% gives Merton's (1971) unconstrained optimal portfolio leverage x=μ/[(1−γ)σ²] where drift μ=R−r_{f}+½·σ² in a continuous random walk model. Optimal leverage from Kelly's criterion formulae x=μ/σ² is a further special case that an investor has a myopic logarithmic utility function with γ=0.

Cvitanic and Karatzas (1995) extended the continuous optimal drawdown control strategy to a case of multiple risky assets. However, Klass and Nowicki (2005) countered that a discrete implementation can result in the loss of portfolio optimality. The discrete trading of DD-COPS uses updated current portfolio value, but the allocation takes full effect with a finite time delay. Loss of portfolio optimality is due to the finite delay and an anchored long term drawdown look-back. Market cycle from decline to recovery can be much longer than the discrete rebalance frequency. Compared to a continuous rebalancing, discrete trading under-weights risky assets during a market downward spiral. Due to long term memory effect of the drawdown control, less exposure to risky asset can cascade into the rebound phase of the market cycle, leading to lower long term accumulated returns.

The recent market cycle since late 2007 provides the opportunity to test the loss of optimality problem. With S&P 500 Total Return Index (SPTR) as the risky asset and 3-month US Treasury Bill as the risk free asset, FIG. 1 gives a data-based demonstration by comparing DD-COPS (δ=20%) with a fixed allocation portfolio of 30%/70% SPTR/T-Bill as a reference. The 30%/70% SPTR/T-Bill portfolio is considered to satisfy 20% maximum EDD constraint as well.

As shown in DD-COPS did not make any new Economic Max after 2000. Even when DD-COPS value reached a new high in late 2007, it is still below the T-bill yield compounded high watermark from year 2000. Although the finite EDD extended into the 2008-2009 market decline helped to limit the Max Drawdown to just 12%, it further reduced stock index exposure during 2009-2011 when S&P 500 Index rose sharply. As a result of the cascading effect, the DD-COPS never made a new high in 2011 while the 30%/70% SPTR/T-bill portfolio did.

As shown in Table 0, the 40-year annualized return and “ending multiples” from the 20% DD-COPS turns out to be less than that from the referenced fixed allocation scheme of the 30%/70% SPTR/T-Bill Portfolio. Both satisfy the maximum EDD<20% risk control constraint during the 40.5% back test period. This example thus demonstrates a situation that DD-COPS can lose optimality in terms of long term portfolio return rate.

TABLE 1
20% DD-COPS vs. the 30/70 SPTR/T-Bill Portfolio and SPTR Index
Performance Statistics for 40.5 Years (1971-2011 Jun. 30)

| | | 30-70 | 20% Target |
|---|---|---|---|
| | SPTR | Stock/T-Bill | DD-COPS |
| Annualized Return | 10.18% | 7.27% | 7.10% |
| Annualized Std Deviation | 15.51% | 4.69% | 4.89% |
| Max EDD | 55.65% | 19.77% | 18.31% |
| Average EDD | 15.59% | 4.39% | 8.41% |
| Max Drawdown | 50.95% | 17.35% | 12.01% |
| Sharpe Ratio | 0.291 | 0.343 | 0.294 |
| Average Total Exposure | 100% | 30% | 30.61% |
| Max Total Exposure | 100% | 30% | 49.50% |
| Ending Multiple (40.5 years) | 50.69 | 17.18 | 16.10 |
| Skew | −0.448 | −0.454 | −1.037 |
| Excessive Kurtosis | 1.996 | 2.135 | 7.620 |

### BRIEF DESCRIPTION OF THE FIGURES

FIG. 1 is an exemplary illustration of the major stages of the method invention of rebalancing investment portfolio to achieve control of maximum economic drawdown losses;

FIG. 2 is an exemplary illustration of a flow chart for managing a Rolling Economic Drawdown—Controlled Portfolio Strategy (REDD-COPS) in accordance to an embodiment of the invention.

FIG. 3 is an exemplary illustration of an electronic pricing and trading system in accordance to an embodiment of the invention.

FIG. 4 is an exemplary illustration of choice of risky assets based low long term correlation coefficients: 20 year trailing coefficients of pairs of among S&P 500 Total Return Index (SPTR), Barclays US Treasury 20+ Year Bond Index (TLT) and Goldman Sachs Commodity Index (GSCI).

FIG. 5 is an exemplary illustration of the effects from rebalancing frequency on REDD-COPS portfolio performance.

FIG. 6 is an exemplary illustration of choose of a longer time scale to decide the expected Sharpe ratios to use for risky assets: 20 year rolling Sharpe ratios of S&P 500 Total Return Index (SPTR), Barclays US Treasury 20+ Year Bond Index (TLT) and Goldman Sachs Commodity Index (GSCI).

FIG. 7 is an exemplary illustration of REDD-COPS sample performance history of Rolling Return, Rolling Economic Drawdown Risk, and Total Risky Asset Exposure.

FIG. 8 is an exemplary illustration of hypothetical wealth growth of a 20% REDD-COPS in comparison with those of its component benchmark indexes.

FIG. 9 is an exemplary illustration of a hypothetical wealth growth of a 20% DD-COPS with single risky asset SPTR versus 30%/70% SPTR/T-Bill Portfolio for 40.5 Years (Jan. 2, 1971, to Jun. 30, 2011) with monthly frequency of rebalancing.

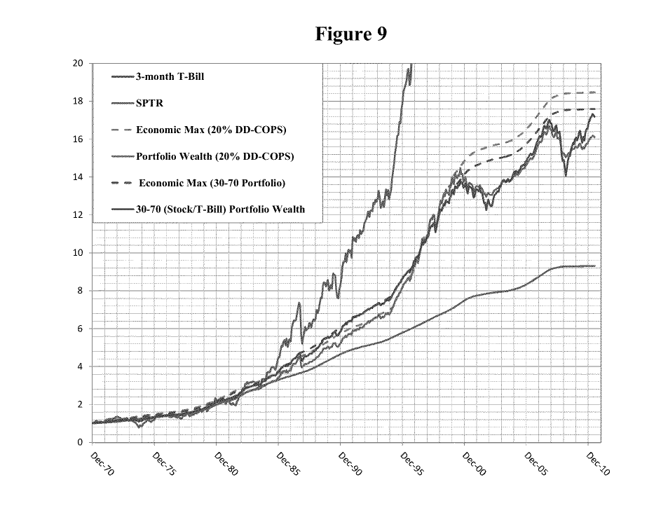

### SUMMARY

In accordance with one embodiment of the present invention, a computer-implemented method and electronic system periodically select portfolio weightings for each of the plurality of assets to rebalance the investment portfolio at a pre-specified frequency. With a risk free asset, the portfolio can be optimal by maximizing long term expected returns while constraining the risk of losses within a pre-determined limit.

Rather than return standard deviation, a portfolio risk measure called Rolling Economic Drawdown (REDD) is invented. Considering current and historical risk free interest rates, REDD represents the maximum economic opportunity loss within a rolling time window of fixed or variable look-back length. The pre-determined limit for REDD can be selected as the complement of constant relative risk aversion coefficient, reflecting the level of risk tolerance. The dynamic weighting of each risky asset can be derived from the assets' long term expected Sharpe ratios and the assets' shorter term updated measure of correlations and volatilities.

### DETAILED DESCRIPTION

Economic Drawdown (EDD) in the continuous DD-COPS reflects an idealistic mental accounting from sophisticated investors: how much better off if they have exited the risky asset completely at a retrospective perfect time in history, when a risk free rate compounded historical high was achieved. However, not all investors invested or had memory since time zero—there are portfolio inception difference among investors. There are also liquidity constraints: not all investors can exit at a perfect time. Hedge fund's initial 1-year lock-up and quarterly redemption window, mutual fund minimum holding period or redemption penalty are examples of restrictions. Practically, at time of a market cycle bottom, using a drawdown reference lower than Economic Max (EM) can improve performance as a forward looking market timing mechanism.

In accordance with one embodiment, an alternative to the anchored time window (since portfolio inception) for EDD calculation is proposed: a fixed or variable rolling time window. Define a Rolling Economic Max (REM) at time t, looking back at portfolio wealth history for a rolling window of length H:

$$REM ( t , H ) = {Max}_{t - H \leq s \leq t} [ {( 1 + {r}_{f} )}^{t - s} {W}_{s} ] ,$$

where r_{f} is the geometric averaging rebalance period return from time s to current t.

In accordance with one embodiment, at earlier time periods when t<H, REM is reduced to an anchored economic max (EM) since portfolio inception time zero:

$$EM ( t ) = {Max}_{0 \leq s \leq t} [ {( 1 + {r}_{f} )}^{t - s} {W}_{s} ] .$$

In accordance with one embodiment, a dual-loop computing algorithm can be used to compute REM: the first inner loop computes H number of compounded portfolio values (with s changes from t−H to t−1), and the second outer loop goes through the H computed values and the current portfolio value Wt to find the largest one as the current Rolling Economic Max (REM) portfolio value.

In accordance with one embodiment, alternatively, a second definition of Rolling Economic Max can be:

$${REM}_{t} = \{ \begin{matrix}{Max}_{0 \leq s \leq t} [ {{W}_{t - s} ( 1 + {r}_{f} )}^{s} ] , t - τ \leq H \\ Max [ {W}_{t} , {{W}_{t - H} ( 1 + {r}_{f} )}^{H} ] , t - τ > H\end{matrix} \\ where \\ τ ( t ) = {max}_{s < t} ( s \vert {REM}_{s} = {W}_{s} )$$

This can also simplify the dual loop computing of REM if REM has not been the portfolio value itself for a time period longer than the look-back time span H.

The two definitions of REM are the same most of the time, but the second one compounds portfolio value since H period ago at risk-free rate if it has not been renewed by a portfolio value over time period H.

In accordance with one embodiment, the Rolling Economic Draw-down (REDD) can be invented and calculated from REM and the current portfolio value Wₜ:

$$REDD ( t , H ) = 1 - \frac{{W}_{t}}{REM ( t , H )}$$

A drawdown look-back period H should be chosen as somewhat shorter than or similar to the market decline cycle, say half a year to five years. Thus the choice of H can be fixed or variable from time to time, depending on the market cycle expectation. In accordance with one embodiment, a fixed rolling drawdown look-back time span of H=1 year can be used.

Since EM≧REM from the fact that REM only examines a part of the historical time window of EM's, REDD≦EDD. Due to replacing EDD with a lower REDD in risky asset weight of DD-COPS, higher risky asset allocation can improve portfolio return during a market rebound phase.

The original DD-COPS have two risk tolerance parameters: drawdown control target δ and risk aversion complement γ. Grossman and Zhou (1993) did not make a direct connection between them. A more risk-averse investor should have a lower drawdown loss tolerance.

In accordance with one embodiment, investor risk profile is characterized as risk aversion complement γ equals drawdown control target δ. In comparison, Kelly's formulae (x=μ/σ²) implies that investor can tolerate 100% drawdown loss (δ=1) whereas assuming logarithmic wealth utility (γ=0), the conservative limit of power law utility functions.

In accordance with one embodiment, a Rolling Economic Drawdown—Controlled Portfolio Strategy (REDD-COPS) can be defined as: a periodically rebalanced investment portfolio among a plurality of risky asset(s) and a risk free asset according dynamically calculating weights, such that the long term expected portfolio return rate is maximized under a dynamic constraint of REDD≦δ. δ can be in a wide range, say zero to 50% for a risk-averse investor; typically 20% of drawdown loss limit represents a balanced risk profile, while 25% represents growth to aggressive profile and 10%-15% represents conservative to moderate profile.

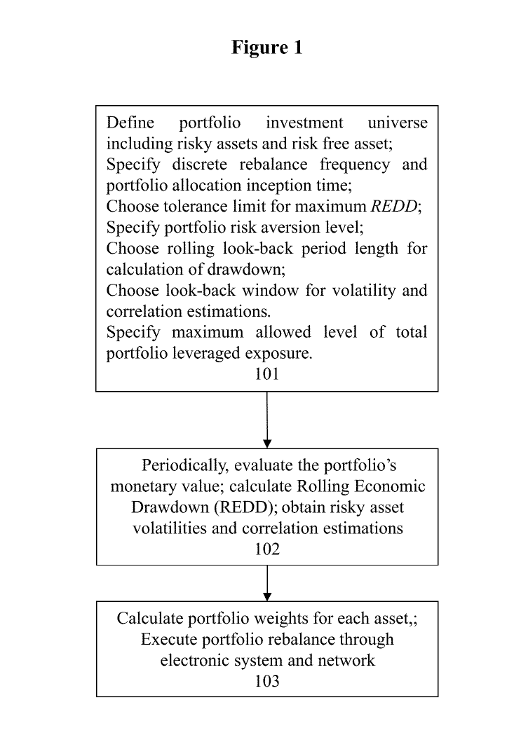

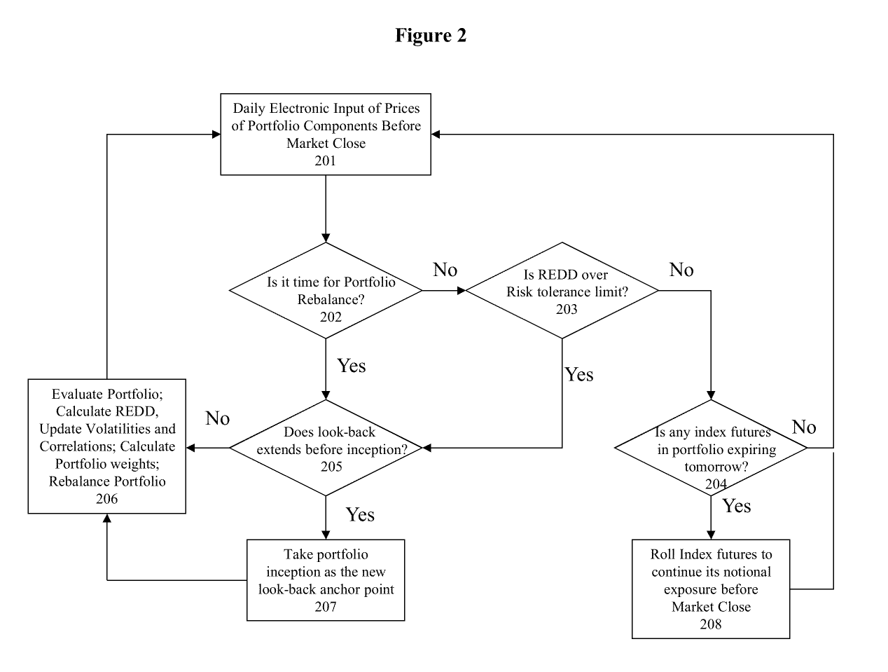

In accordance with one embodiment, the REDD-COPS can be implemented in three stages in the practice of investment portfolio management or benchmark index management, as shown in FIG. 1, the initial specification stage 101; the periodic calculation stage 102, the periodic weighting and rebalance transaction stage 103. The details of the specification, calculation and transaction process/data flow and logic control are indicated in FIG. 2's steps 201-208.

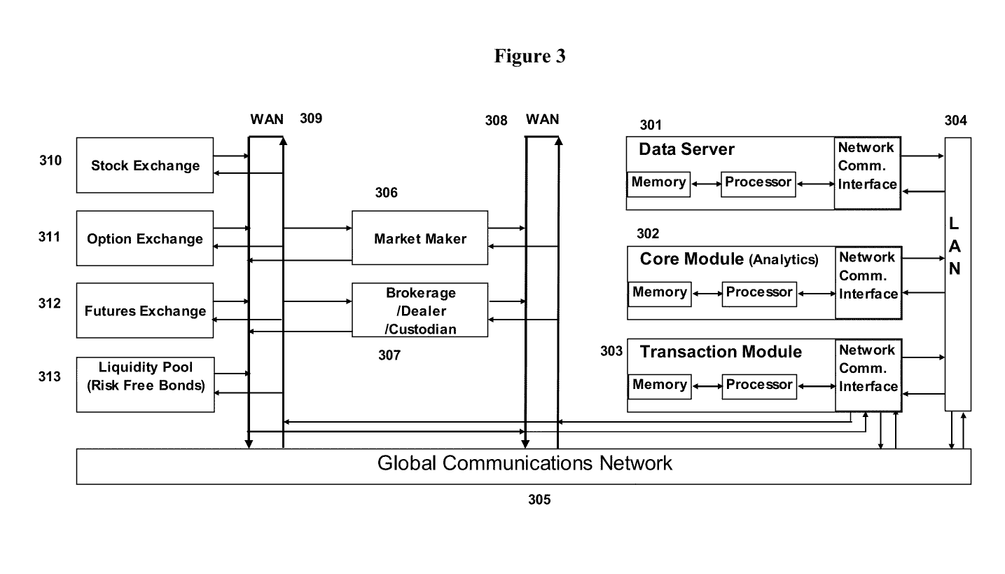

As shown in FIG. 3, the electronic pricing and transaction system 300 includes two groups of entities. The first group is a major computer platform responsible for constructing financial investment portfolios or benchmark indexes. It can include a data server module 301, a core module 302 and a transaction module 303. Each module has electronic memory, single or multiple processors, and network communication interface. Each network communication interface enables the respective module to transmit information to or from a local area network (LAN) 304. LAN further allows connection with a Global Communications Network 305. Data server module 301 is responsible for accepting, storing and providing historical and current prices of relevant securities, instruments, market indexes and other benchmark information. The core module 302 handles investment related logic, analytics and decision-making tasks based on prices and other data input from LAN 304. The transaction module 303 allows generating buy or sell order(s) for a security or securities. The LAN 304 or Global Communications Network 305 further transmits the security price and order information to and from the second group of platform entities. In order to improve speed and reliability of data transmission and order execution, the network communication interface of the transaction module 303 can have direct connection with the second group of platform entities. The second group of platform entities can be of two types. One type is a financial exchange platform, including but not limited to stock exchange(s) 310, option exchange(s) 311, futures exchanges 312, and liquidity pool 313 such as the price quoting and trading platform for providers or buyers of risk free bonds. Another type is financial intermediaries, including but not limited to market maker(s) 306 and brokerage, dealers or custodians 307. Exchange platform entities can connect to a Wide Area Network (WAN) 309 which further has price and order flow exchange with Global Communications Network 305 or directly with network communication interface of transaction module 303. The platform of financial intermediaries can connect to a Wide Area Network (WAN) 308 which further has price and order flow exchange with Global Communications Network 305 or directly with network communication interface of transaction module 303.

In accordance with one embodiment, at least one of the modules within the first group of platform entities, usually the core module 302 can perform the computation of the technical rules and portfolio allocation weights. Using price and order information feed of all components of the portfolios, the core module 302 can compute the value of the portfolio's component benchmark indexes and the total value of financial investment instruments and portfolios, and transmit the data tick by tick in market hours back to the members of the second group of platform entities.

In accordance with one embodiment, the pricing and transaction process in the electronic system can be described as: the Exchange platform (310, 311, 312 and 313) posts bid-ask securities or index prices, order volumes and other market index information tick by tick during market hours to its member affiliates through WAN 309 and Global Communication Network 305. Market maker 306 and broker dealer 307 can further post their price and order information through WAN 308 and Global Communication Network 305. The constructor of financial investment portfolios and benchmark indexes that are referencing a reference portfolio such as the Rolling Economic Drawdown Controlled Portfolio (REDD-COPS), usually the first group of platform entities, takes the feed of the prices, indexes and orders information through LAN 304 or directly from network interface of transaction module 303. Data server module 301 stores current and historical price and order information feed from LAN 304. Core module 302 utilizes data feed from Data server module 201 through LAN 304 as input and outputs actual or hypothetical transaction instructions to transaction module 303 through LAN 304. After the confirmation of the actual or hypothetical transaction prices from transaction module 303, core module 302 also output values of benchmark indexes and financial investment instruments or portfolios, and their component allocation and values, including option overlays, to market maker 306, broker-dealer/custodian 307 or exchange platforms (310, 311, 312 and 313) through LAN 304, Global Communication Network 305, and WAN 308 and WAN 309.

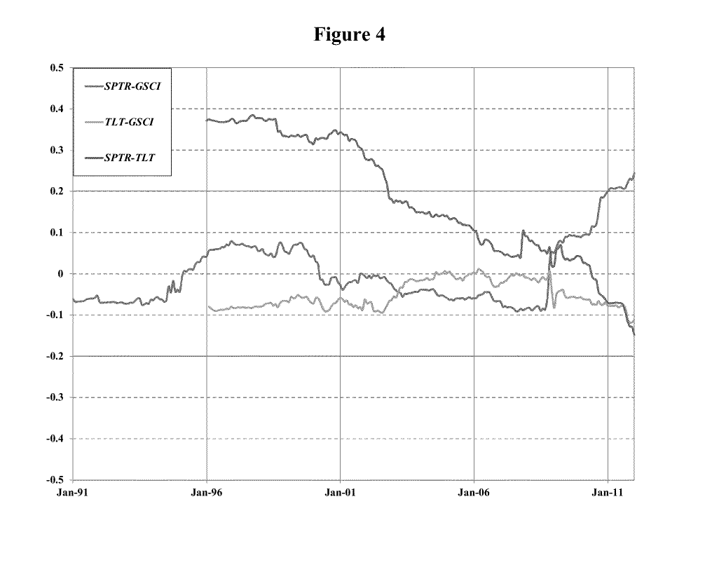

In accordance with one embodiment, S&P 500 Total Return Index (SPTR), Barclays US Treasury 20+ Year Bond Index (TLT) and Goldman Sachs Commodity Total Return Index (GSCI) are chosen as three risky assets, and US 3-month Treasury Bill (T-Bill) is chosen as the risk free asset. To achieve diversification benefit, the investment universe of risky assets should represent uncorrelated or almost uncorrelated asset classes based on their historical return time series. FIG. 4 records 20-year trailing correlation coefficients of SPTR-TLT, TLT-GISCI and GSCI-SPTR pairs by end of 2011. It is clear for twenty years (1992-2011) the correlation coefficient between each pair of three asset class indexes are less than 0.3, a threshold that represent relative low correlations. In practice, the selected investable risky assets can be, but not limited to: equity market index futures contracts, ETF's or index mutual funds; fixed income index futures contracts, ETF's or mutual funds; and commodity futures contract, commodity index ETF/ETN's or mutual funds.

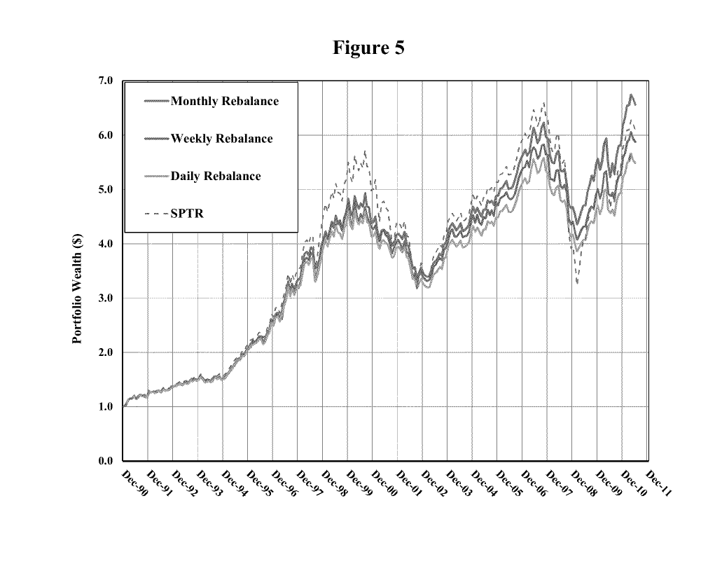

In accordance with one embodiment, a monthly frequency is used to rebalance among risky asset(s) and risk free asset of the REDD-COPS portfolio. FIG. 5 compares back-tested portfolio wealth growth histories of daily, weekly and monthly rebalance frequencies for a SPTR/T-Bill 30% REDD-COPS portfolio from January 1991 to June 2011. Clearly the monthly rebalance frequency out-performed. For the period, the monthly return time series of SPTR has a one-step-lag auto-correlation coefficient of 0.118, compared to weekly series' −0.081 and daily series' −0.062. Thus the out-performance of monthly rebalance can be explained by a stronger tendency of gain or loss to continue for the next period, compared to a weekly or daily rebalanced scheme. Thus when choosing a daily, weekly, bi-weekly, monthly, quarterly or annual frequency for portfolio rebalancing, one can compare the statistical lag-one step serial correlation coefficients of the historical return time series of the risky assets and preferably select the frequency with the largest lag-one period serial correlation coefficient.

In accordance with one embodiment, the choice of REDD look-back period length H can consider the effect of central bank's market friendly monetary policy after major market decline. Thus the expected market cycle bottom can be estimated as the starting time of market response to central bank's monetary policy to address market stress or crash. As such, H can be approximated as or slightly shorter than the time span from last market high to current expected bottom. For example, in the case of the 2008 financial crisis, His about one year to 15 months from December 2008 to February 2009 in US.

In accordance with one embodiment, the REDD-COPS portfolio can have a limit of total leveraged exposure to risky assets L. The total leveraged exposure from risky assets might exceed what is allowed by exchange or brokerage rules. The limit can be decided from the normalized weighted average exposure limit of each risky asset instrument used in the portfolio, usually set by a trading brokerage or exchange specifically for that instrument. For example, S&P 500 Index futures allows a margin ratio of 7.5: 1; US 30 Year T-Bond futures 17.5:1; and Oil futures 10:1, and the normalized allocation of the three instruments in the portfolio is 60%, 20% and 20%, respectively, then L=0.6×7.5+0.2×17.5+0.2×10=10=1000%. This relates to the instrument used to gain exposure for a risky asset class. If the US 30-Year T-Bond is directly purchased rather than a position in futures contracts while other positions are the same in the example, L=0.6×7.5+0.2×1+0.2×10=6.7=670%.

In accordance with one embodiment, the weight in the single risky asset of a one risky asset REDD-COPS portfolio is:

$${w}_{t} = Max \{ 0 , Min ( L , \frac{λ / σ + 1 / 2}{1 - {δ}^{2}} [ \frac{δ - REDD ( t , H )}{1 - REDD ( t , H )} ] ) \}$$

In accordance with one embodiment, the pre-weights of a two risky asset REDD-COPS portfolio are:

$$[ \begin{matrix}{x}_{1} \\ {x}_{2}\end{matrix} ] = \frac{1}{1 - {ρ}^{2}} [ \begin{matrix}( {λ}_{1} + 1 / 2 {σ}_{1} - ρ \cdot ( {λ}_{2} + 1 / 2 {σ}_{2} ) ) / {σ}_{1} \\ ( {λ}_{2} + 1 / 2 {σ}_{2} - ρ \cdot ( {λ}_{1} + 1 / 2 {σ}_{1} ) ) / {σ}_{2}\end{matrix} ] \cdot Max [ 0 , \frac{1}{1 - {δ}^{2}} \cdot ( \frac{δ - REDD}{1 - REDD} ) ]$$

and the weights are: wᵢ=xᵢ·min(L,Σxᵢ)/(Σxᵢ). When risky assets have positive Sharpe ratios (λ_{1,2}>0), the necessary condition of no short position in any of the two risky assets is ρ≦0 or

$$ρ < ( {λ}_{1} + \frac{1}{2} {σ}_{1} ) / ( {λ}_{2} + \frac{1}{2} {σ}_{2} ) < 1 / ρ ( ρ < 0 ) .$$

In accordance with one embodiment, the pre-weights of a three risky asset REDD-COPS portfolio are:

$$[ \begin{matrix}{x}_{1} \\ {x}_{2} \\ {x}_{3}\end{matrix} ] = \frac{1}{1 - {θ}^{2}} \cdot [ \begin{matrix}{C}_{1} \\ {C}_{2} \\ {C}_{3}\end{matrix} ] \cdot Max [ 0 , \frac{1}{1 - {δ}^{2}} \cdot ( \frac{δ - REDD}{1 - REDD} ) ] \\ [ \begin{matrix}{C}_{1} \\ {C}_{2} \\ {C}_{3}\end{matrix} ] = [ \begin{matrix}\{ \begin{matrix}\begin{matrix}( {λ}_{1} + 1 / 2 {σ}_{1} ) ( 1 - {ρ}_{23}^{2} ) + \\ ( {λ}_{2} + 1 / 2 {σ}_{2} ) ( {ρ}_{23} {ρ}_{13} - {ρ}_{12} ) +\end{matrix} \\ ( {λ}_{3} + 1 / 2 {σ}_{3} ) ( {ρ}_{23} {ρ}_{12} - {ρ}_{13} )\end{matrix} \} / {σ}_{1} \\ \{ \begin{matrix}\begin{matrix}( {λ}_{2} + 1 / 2 {σ}_{2} ) ( 1 - {ρ}_{13}^{2} ) + \\ ( {λ}_{1} + 1 / 2 {σ}_{1} ) ( {ρ}_{13} {ρ}_{23} - {ρ}_{12} ) +\end{matrix} \\ ( {λ}_{3} + 1 / 2 {σ}_{3} ) ( {ρ}_{13} {ρ}_{12} - {ρ}_{23} )\end{matrix} \} / {σ}_{2} \\ \{ \begin{matrix}\begin{matrix}( {λ}_{3} + 1 / 2 {σ}_{3} ) ( 1 - {ρ}_{12}^{2} ) + \\ ( {λ}_{1} + 1 / 2 {σ}_{1} ) ( {ρ}_{23} {ρ}_{12} - {ρ}_{13} ) +\end{matrix} \\ ( {λ}_{2} + 1 / 2 {σ}_{2} ) ( {ρ}_{13} {ρ}_{12} - {ρ}_{23} )\end{matrix} \} / {σ}_{3}\end{matrix} ]$$

$${θ}^{2} = {ρ}_{12}^{2} + {ρ}_{23}^{2} + {ρ}_{31}^{2} - 2 {ρ}_{12} {ρ}_{23} {ρ}_{13}$$

and the weights are wᵢ=xᵢ·min(L,Σxᵢ)/(Σxᵢ). Weighting in risk free asset is the remaining from 100% after cash investments or collateral allocation in risky assets.

In accordance with one embodiment, the pre-weights of multiple risky assets REDD-COPS can be calculated as:

$${[ x ]}^{T} = ( {[ {\sum }^{- 1} \cdot μ ]}^{T} \cdot {\sum }^{- 1} ) \cdot max ( 0 , \frac{1}{1 - {δ}^{2}} \cdot \frac{δ - REDD}{1 - REDD} ) ,$$

where Σ is variance-covariance matrix of the risky assets' returns. Further the weight for each risk asset is: wᵢ=xᵢ·min(L,Σxᵢ)/(Σxᵢ). The vector

$$( {[ {\sum }^{- 1} \cdot μ ]}^{T} \cdot {\sum }^{- 1} )$$

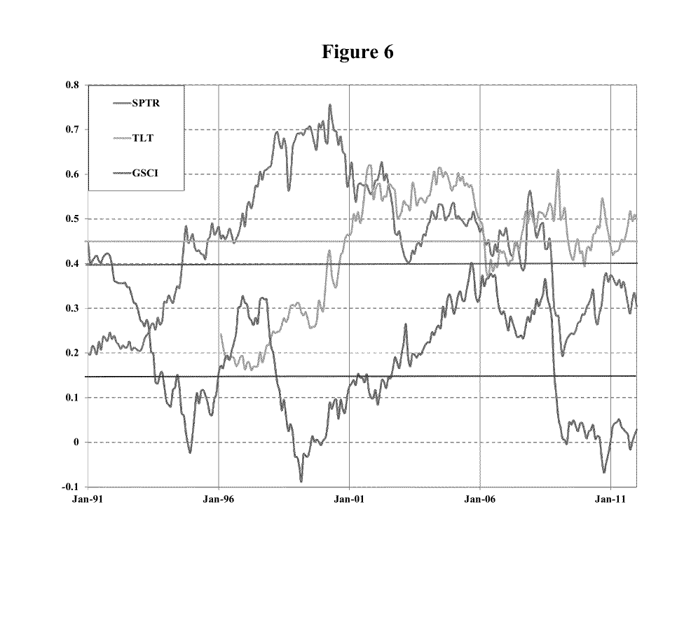

can be analytically expressed in a reduced symbolic form of only Sharpe ratios, correlation coefficients and standard deviations as for the single, two or three risky assets REDD-COPS cases. The benefit is that active view can be introduced separately only for correlation coefficients and volatilities for the risky assets in the dynamic asset allocation process. Expected Sharpe ratios in the model portfolio allocation process can be separately treated as constants, taking the average value over a longer term time period of at least ten years. For example, from FIG. 6's 20-year rolling Sharpe ratios, average expected Sharpe ratios for SPTR, TLT and GSCI Indexes can be approximately taken as λ̅_{SPTR}=0.4, λ̅_{TLT}=0.45 and λ̅_{GSCI}=0.15.

In accordance with one embodiment, when the correlation coefficients between risky assets are low and approximated as zeros, the pre-weights for REDD-COPS portfolio rebalance can be simplified as:

$${x}_{i} = ( \frac{{\overline{λ}}_{i}}{{\overline{σ}}_{i} ( t , h )} + \frac{1}{2} ) \cdot Max ( 0 , \frac{1}{1 - {δ}^{2}} \cdot \frac{δ - REDD ( t , H )}{1 - REDD ( t , H )} )$$

and further the weights: wᵢ=xᵢ·min(L,Σxᵢ)/(Σxᵢ).

In accordance with one embodiment, as part of REDD-COPS asset allocation weighting process, the expected volatilities and correlations of risky assets are calculated periodically at rebalancing frequency with a chosen look-back time window h. The look-back length for volatilities and correlations is chosen as much shorter than the time scale for expected Sharpe ratios, but longer than rebalance time interval. It can be chosen to match the drawdown look-back H, such as one year, or shorter. The frequency of periodic return time series to calculate volatilities and correlations can be chosen as the portfolio rebalance frequency or shorter. For example, daily, weekly or monthly return data can be used to estimate volatilities and correlations for a monthly rebalanced REDD-COPS portfolio.

In accordance with one embodiment, the calculated exact portfolio weights can be further rounded in practice into fixed increments, such as an integer percentage, or integer share or number of contracts for transaction.

In order to control rolling economic drawdown (REDD) losses during the time of one rebalance period interval, the portfolio value can be quoted and monitored at a shorter time scale than the rebalancing frequency. For example, a monthly rebalanced REDD-COPS portfolio posts daily or weekly portfolio monetary net values. REDD can be calculated based on the updated portfolio value at the shorter time intervals.

In accordance with one embodiment, the position of all risky assets in the portfolio can be closed at a time during a rebalance period. When REDD gets close to, for example less than one percent, or exceeds the specified control limit δ of maximum allowed REDD, all risky assets can be sold and portfolio only holds risk free assets. As time progresses while the rolling time window of length H advances, REDD can decrease away from the control limit such that the portfolio can invest back into risky asset at a rebalance time.

Choosing SPTR, TLT and Dow Jones-UBS Commodities Total Return Index (DJBUS) to represent risky assets and 3-month US T-bill as risk free asset, a back test for the twenty year period (1992-2011) is performed with monthly rebalance for REDD-COPS. Expected long term Sharpe ratios are fixed as constants of λ̅_{SPTR}=0.4, λ̅_{TLT}=0.45 and λ̅_{DJUBS}=0.15 with zero correlations approximation. Specify H=h=one year for rolling time windows for REDD calculation and volatility updating calculation. Numerical results in Table 2 indicate for three REDD control limits of 15%, 20% and 25%, REDD-COPS out-perform their component benchmark indexes and other fixed combination indexes including 60%/40% SPTR/TLT, Minimum Variance Portfolio (MVP) of SPTR/TLT, and 60% levered Risk Parity Portfolio (RPP) of SPTR/TLT. The 20% REDD-COPS example control realized REDD all within their respectively limit.

TABLE 2
Performance Statistics of REDD-COPS vs. Component and Other Indexes (1992-2011)

| | | | | SPTR-TLT | | | SPTR-TLT-DJUBS | | |
|---|---|---|---|---|---|---|---|---|---|
| | | | | Fixed Allocation | | | Risk-based | | |
| | | | | Portfolio | | | REDD-COPS | | |
| | Single Index | | | | | 60% | 15% | 20% | 25% |
| | Buy & Hold | | | Balanced | | Levered | REDD | REDD | REDD |
| | SPTR | TLT | DJUBS | (60-40) | MVP | RPP | Target | Target | Target |
| Annualized Return | 7.81% | 8.93% | 5.65% | 8.79% | 9.04% | 11.29% | 11.06% | 13.71% | 16.45% |
| Annualized Std Deviation | 15.00% | 11.37% | 15.23% | 9.46% | 8.40% | 13.35% | 10.29% | 13.98% | 17.90% |
| Sharpe Ratio | 0.301 | 0.495 | 0.154 | 0.580 | 0.683 | 0.598 | 0.754 | 0.745 | 0.734 |
| Average REDD | 7.21% | 5.64% | 8.01% | 4.31% | 3.68% | 5.45% | 3.69% | 5.01% | 6.41% |
| Max REDD | 46.76% | 21.51% | 54.48% | 26.68% | 20.51% | 26.04% | 14.65% | 19.68% | 24.85% |
| Max Drawdown | 50.95% | 21.40% | 54.26% | 28.63% | 19.09% | 28.16% | 13.98% | 19.00% | 24.10% |
| Maximum Exposure | 100% | 100% | 100% | 100% | 100% | 160% | 292.3% | 396.8% | 507.9% |
| Average Exposure | 100% | 100% | 100% | 100% | 100% | 160% | 143.3% | 195.2% | 250.3% |
| Ending Multiple | 4.501 | 5.533 | 3.001 | 5.389 | 5.641 | 8.489 | 8.143 | 13.065 | 21.014 |

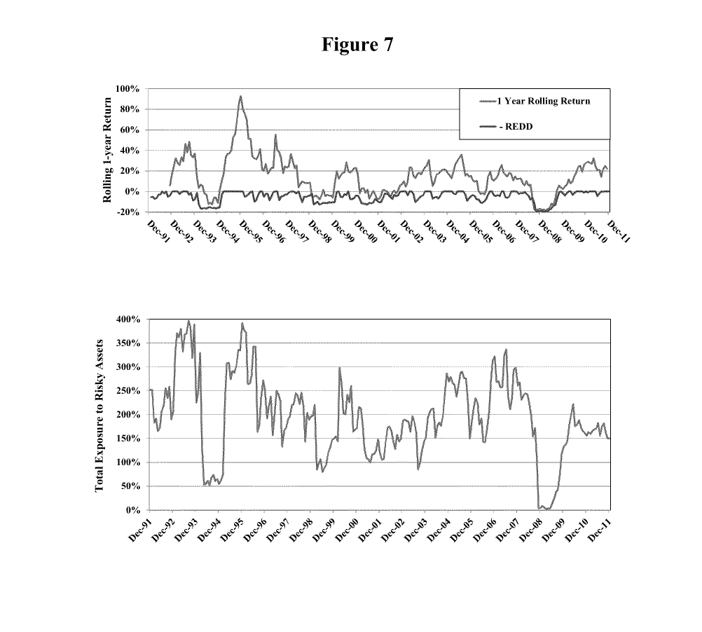

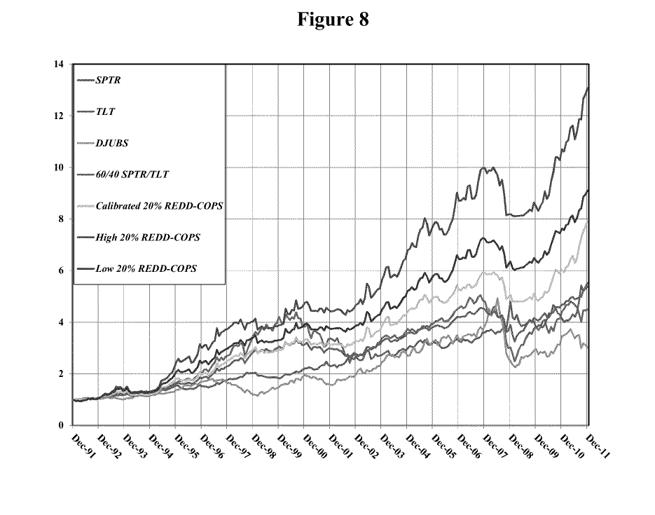

FIG. 7 illustrates time-varying histories of rolling return, REDD, and total portfolio exposure to risky assets in the 20% REDD-COPS portfolio. FIG. 8 illustrates its hypothetical portfolio value growth over a time span of twenty years of 1992 to 2011 as the highest in comparison. The in-sample REDD-COPS differ in the absence of zero correlation and constant in-sample volatilities and correlation without periodic updates. The low 20% REDD-COPS differ in using constant Sharpe ratios for three component indexes of lower sum at 0.7.

In accordance with one embodiment, an investable benchmark portfolio index or a family of performance benchmark indexes, tracking the Rolling Economic Drawdown-Controlled Portfolio Strategy (REDD-COPS) can be constructed by electronically feeding the portfolio model's recorded value at tick-by-tick or daily time frequency into the electronic system of an exchange or a benchmark index data provider, wherein an investment portfolio's long term return rate subject to a specific choice of rolling economic drawdown (REDD) constraint limit can be compared.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, micro-drive, and magneto-optical disks, ROMs, RAMs, EPROMs, EEPROMs, DRAMs, VRAMs, flash memory devices, magnetic or optical cards, nano-systems (including molecular memory ICs), or any type of media or device suitable for storing instructions and/or data.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer-implemented method for rebalancing an investment portfolio with a plurality of assets that include one or more risk-free asset(s) and one or more risky asset(s), comprising:
specifying discrete rebalance frequency and portfolio allocation inception time;
choosing maximum tolerance limit for Rolling Economic Drawdown (REDD);
choosing a level of constant relative risk aversion to represent portfolio risk tolerance;
choosing a rolling look-back period length for calculating drawdown;
obtaining a maximum level of total leveraged exposure in risky assets that the investment portfolio is allowed;
obtaining current and historical interest rates of the one or more risk free assets;
obtaining long term expected Sharpe ratios of the one or more risky assets;
obtaining risky asset volatilities and correlation estimations
evaluating the portfolio's monetary value and calculating REDD; and
calculating asset allocation weight for each asset.

2. A computer-implemented method according to claim 1, further comprising periodically adjusting portfolio weightings for each of the plurality of assets to optimally rebalance the investment portfolio.

3. A computer-implemented method according to claim 1, wherein calculating Rolling Economic Drawdown (REDD) for the portfolio comprises of at least one of
obtaining current and historical risk free interest rates over a rolling time window
obtaining current and historical portfolio monetary value over a rolling time window
calculating Rolling Economic Max (REM) for the portfolio, as the highest among the current portfolio value and any risk-free interest rate compounded value from a past portfolio value within a rolling time window; and
calculating REDD as the rate of losses of current portfolio value off from REM.

4. A computer-implemented method according to claim 1, further comprising specifying portfolio rebalancing frequency by
calculating lag-one period return serial correlation coefficients; and
choosing rebalance period frequency with a higher lag-one serial correlation.

5. A computer-implemented method according to claim 1, further comprising including one or more risky assets for better diversification that have low or near zero historical return correlation coefficients to each other.

6. A computer-implemented method according to claim 1, further comprising choosing a level of complement of constant relative risk aversion as directly correlating to maximum tolerance limit for drawdown loss measure.

7. A computer-implemented method according to claim 1, further comprising choosing a rolling look-back period length for calculating drawdown, according to quantities related to at least one of
a length of market cycle from peak to trough, and
expected starting time of market recovery due to central bank policy since last pre-decline market peak.

8. A computer-implemented method according to claim 1, further comprising obtaining a maximum level of total leveraged exposure allowed for the portfolio, according to maximum allowed level of leverage for each risky asset and/or current portfolio's normalized weight for each risky asset.

9. A computer-implemented method according to claim 1, further comprising providing an investable benchmark portfolio index or a family of performance benchmark indexes, tracking the time varying value of Rolling Economic Drawdown-Controlled Portfolio (REDD-COPS) through electronic systems and network.
